(19) United States
(12) Patent Application Publication
(10) Pub. No.: US 2015/0112765 A1
(43) Pub. Date: Apr. 23, 2015

(54) SYSTEMS AND METHODS FOR DETERMINING RECRUITING INTENT

(71) Applicant: Linkedln Corporation, Mountain View, CA (US)

(72) Inventors: Suman Sundaresh, Cupertino, CA (US); Andrew P. Hill, San Francisco, CA (US); Deepak Kumar, Mountain View, CA (US); Anmol Bhasin, Los Altos, CA (US)

(73) Assignee: Linkedln Corporation, Mountain View, CA (US)

(21) Appl. No.: 14/060,216

(22) Filed: Oct. 22, 2013

(51) Int. Cl. G06Q 10/10; G06Q 50/00; G06Q 30/02

(52) U.S. Cl. CPC G06Q 10/1053; G06Q 30/0202; G06Q 50/01
USPC 705/7.31

(57) ABSTRACT

Techniques for identifying members of a social network service that exhibit recruiting intent are described. According to various embodiments, a set of members of an online social network service that self-identify as recruiters may be identified. The set of members that self-identify as recruiters may then be clustered into a group of engaged recruiters and a second group of non-engaged recruiters, and the group of engaged recruiters may be categorized as members exhibiting recruiting intent. Behavioral log data associated with the members exhibiting recruiting intent may then be accessed and classified as recruiting intent signature data. Thereafter, prediction modeling may be performed based on the recruiting intent signature data and a prediction model, to identify members of the online social network service that are associated with behavioral log data matching the recruiting intent signature data.

### TECHNICAL FIELD

The present application relates generally to data processing systems and, in one specific example, to techniques for identifying members of an online social network service that exhibit recruiting intent.

### BACKGROUND

Online social and professional networking services are becoming increasingly popular, with many such services boasting millions of active members. In particular, the professional networking website LinkedIn has become successful at least in part because it allows members to actively recruit other members for jobs.

### BRIEF DESCRIPTION OF THE DRAWINGS

Some embodiments are illustrated by way of example and not limitation in the figures of the accompanying drawings in which:

FIG. 1 is a block diagram illustrating various groups in a member base of an online social network service, consistent with some embodiments of the invention;

FIG. 2 is a block diagram showing the functional components of a social networking service, consistent with some embodiments of the invention;

FIG. 3 is a block diagram of an example system, according to various embodiments;

FIG. 4 is a flowchart illustrating an example method, according to various embodiments;

FIG. 5 illustrates an exemplary member profile page, according to various embodiments;

FIG. 6 illustrates an exemplary clustering operation, according to various embodiments;

FIG. 7 illustrates an exemplary operation for training a prediction model, according to various embodiments;

FIG. 8 is a flowchart illustrating an example method, according to various embodiments;

FIG. 9 is a flowchart illustrating an example method, according to various embodiments;

FIG. 10 is a flowchart illustrating an example method, according to various embodiments;

FIG. 11 is a flowchart illustrating an example method, according to various embodiments; and

FIG. 12 is a diagrammatic representation of a machine in the example form of a computer system within which a set of instructions, for causing the machine to perform any one or more of the methodologies discussed herein, may be executed.

### DETAILED DESCRIPTION

Example methods and systems for identifying members of an online social network service that exhibit recruiting intent are described. In the following description, for purposes of explanation, numerous specific details are set forth in order to provide a thorough understanding of example embodiments. It will be evident, however, to one skilled in the art that the present invention may be practiced without these specific details.

According to various exemplary embodiments, a recruiting intent determination system is configured to identify members that exhibit recruiting intent on a social network service such as LinkedIn. For example, the recruiting intent determination system may identify members of an online social network service that exhibit behavior indicating that they have an interest in recruiting and that they are actively using the online social network service for recruiting purposes.

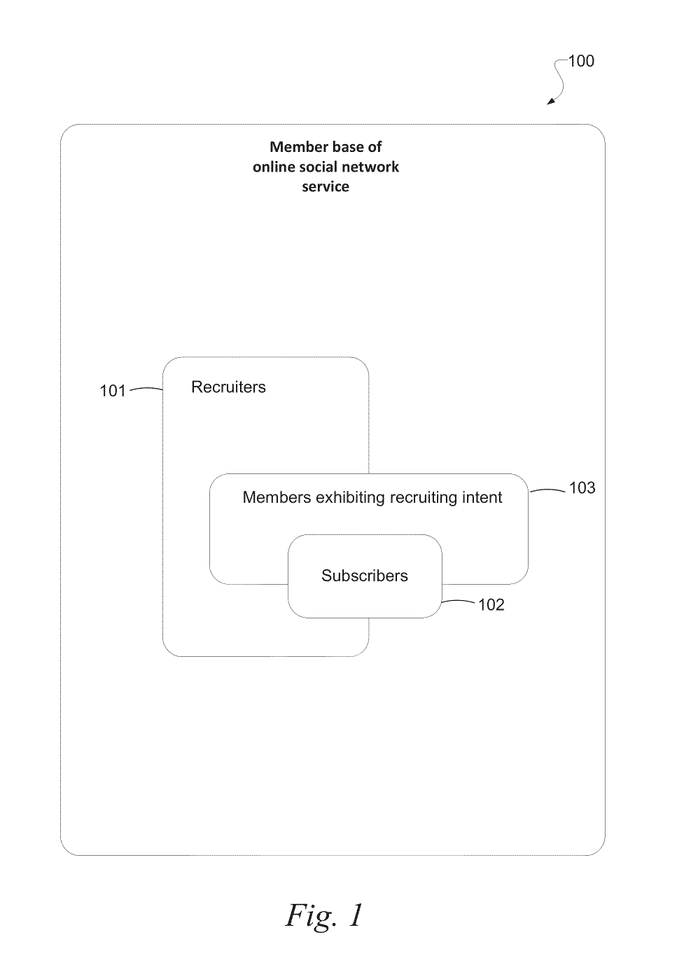

For example, as illustrated in FIG. 1, the member base 100 of an online social network service such as LinkedIn may include recruiters 101 (e.g., the set of members that self-identify as recruiters on their member profile pages), as well as subscribers 102 (e.g., the set of members that may have a subscription to a recruiting-focused service, such as the “Talent Finder” service on LinkedIn). Moreover, the member base 100 illustrated in FIG. 1 also depicts a set of members that exhibit recruiting intent 103. As illustrated in FIG. 1, while some of the recruiters 101 and some of the subscribers 102 may exhibit recruiting intent, many of the recruiters 101 and subscribers 102 do not exhibit such recruiting intent (e.g., they are not engaged members that actively use the online social network service for recruiting). Moreover, as illustrated in FIG. 1, the group of members that exhibit recruiting intent 103 may include members that are neither recruiters 101 nor subscribers 102. Thus, the group of members that exhibit recruiting intent 103 may include a large portion of members that may not self-identify as “recruiters” and/or may not access a recruiting subscription service, even though they may be actively using the online social network service for recruiting purposes (e.g., small and medium business owners, CXO's, investors, managers, etc.). Accordingly, the recruiting intent determination system described herein is configured to identify all the members of an online social network service exhibiting recruiting intent 103 at a given time, which may include a large and unrecognized pool of members who neither self-identify as recruiters nor subscribe to recruiting-focused services, but who are nevertheless actively using the online social network service for recruiting purposes.

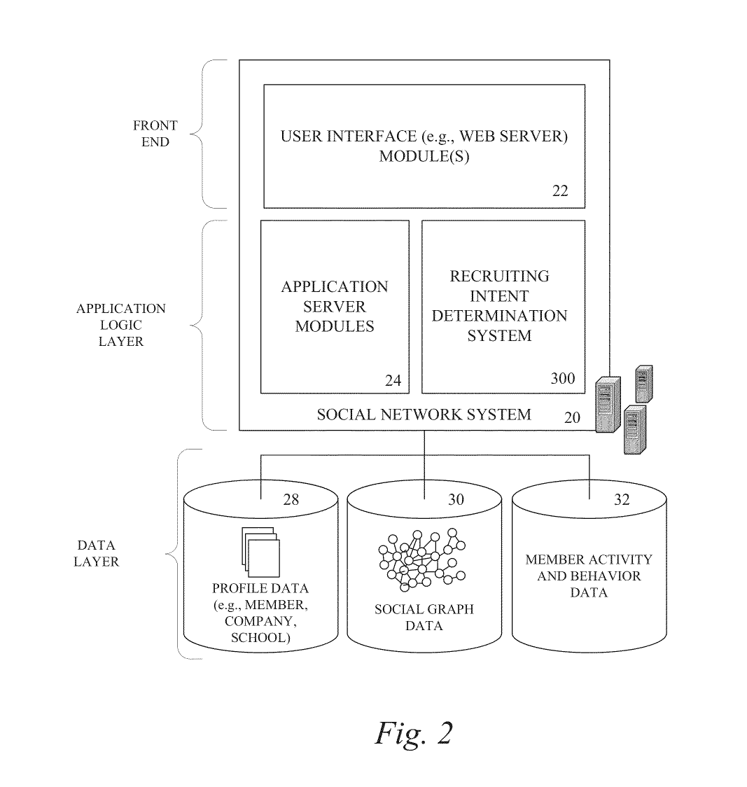

FIG. 2 is a block diagram illustrating various components or functional modules of a social network service such as the social network system 20, consistent with some embodiments. As shown in FIG. 2, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 24. Similarly, a variety of other applications or services that are made available to members of the social network service will be embodied in their own application server modules 24.

As shown in FIG. 2, the data layer includes several databases, such as a database 28 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 2 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 2 by the database with reference number 32. This information may be used to classify the member as being in various categories. For example, if the member performs frequent searches of job listings, thereby exhibiting behavior indicating that the member is a likely job seeker, this information can be used to classify the member as a job seeker. This classification can then be used as a member profile attribute for purposes of enabling others to target the member for receiving messages or status updates. Accordingly, a company that has available job openings can publish a message that is specifically directed to certain members of the social network service who are job seekers, and thus, more likely to be receptive to recruiting efforts.

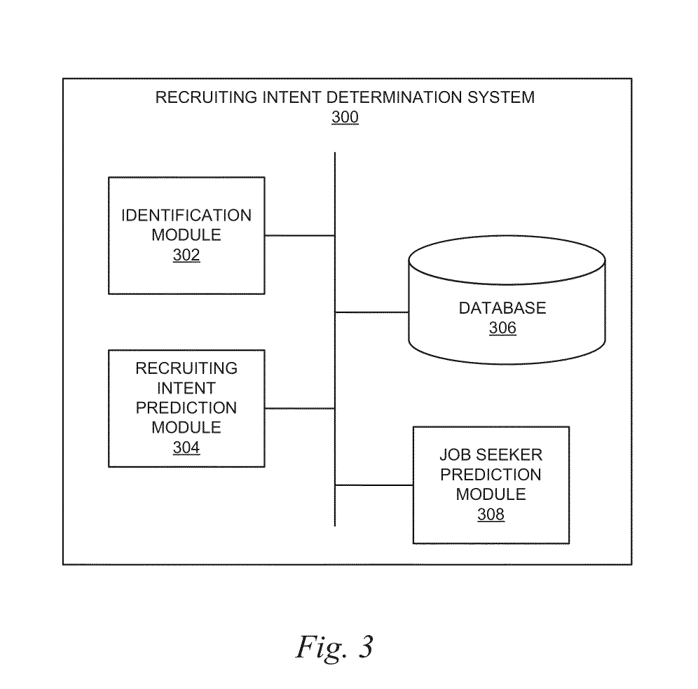

With some embodiments, the social network system 20 includes what is generally referred to herein as a recruiting intent determination system 300. The recruiting intent determination system 300 is described in more detail below in conjunction with FIG. 3.

Although not shown, with some embodiments, the social network system 20 provides an application programming interface (API) module via which third-party applications can access various services and data provided by the social network service. For example, using an API, a third-party application may provide a user interface and logic that enables an authorized representative of an organization to publish messages from a third-party application to a content hosting platform of the social network service that facilitates presentation of activity or content streams maintained and presented by the social network service. Such third-party applications may be browser-based applications, or may be operating system-specific. In particular, some third-party applications may reside and execute on one or more mobile devices (e.g., phone, or tablet computing devices) having a mobile operating system.

Turning now to FIG. 3, a recruiting intent determination system 300 includes an identification module 302, a recruiting intent prediction module 304 (also referred to throughout as prediction module 304 in the interests of brevity), and a database 306. The modules of the recruiting intent determination system 300 may be implemented on or executed by a single device such as a recruiting intent determination device, or on separate devices interconnected via a network. The aforementioned recruiting intent determination device may be, for example, one or more client machines and/or application servers.

As described in more detail below, the identification module 302 is configured to identify a set of members of an online social network service that self-identify as recruiters. The identification module 302 may then cluster the set of members that self-identify as recruiters into a first group of engaged recruiters and a second group of non-engaged recruiters. Moreover, the identification module 302 may categorize the group of engaged recruiters as members exhibiting recruiting intent.

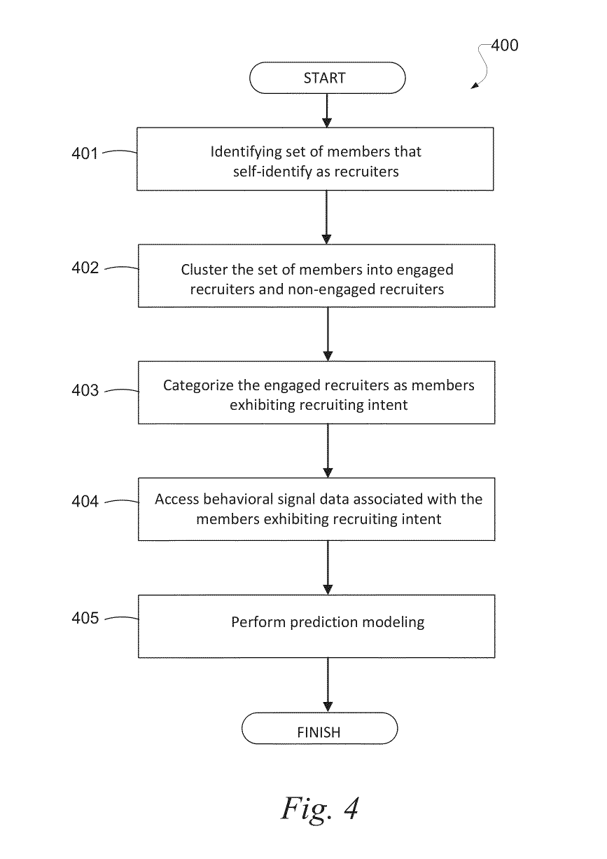

Thereafter, the prediction module 304 is configured to access behavioral log data associated with the members exhibiting recruiting intent, and to classify the behavioral log data as recruiting intent signature data. Moreover, the prediction module 304 is configured to perform prediction modeling based on the recruiting intent signature data and a prediction model (e.g., a logistic regression model), in order to identify members of the online social network service that are associated with behavioral log data matching the recruiting intent signature data. Accordingly, the prediction module 304 may identify all members of an online social network service that exhibit recruiting intent at a given time. The operation of each of the aforementioned modules of the recruiting intent determination system 300 will now be described in greater detail in conjunction with FIG. 4.

FIG. 4 is a flowchart illustrating an example method 400, according to various exemplary embodiments. The method 400 may be performed at least in part by, for example, the recruiting intent determination system 300 illustrated in FIG. 3 (or an apparatus having similar modules, such as a client machine and/or application server). The operations in the method 400 will now be briefly described. In operation 401, the identification module 302 identifies a set of members of an online social network service that self-identify as recruiters. In operation 402, the identification module 302 clusters the set of members that self-identify as recruiters (that were identified in operation 401) into a group of engaged recruiters and a second group of non-engaged recruiters. In operation 403, the identification module 302 categorizes the group of engaged recruiters as members exhibiting recruiting intent. In operation 404, the prediction module 304 accesses behavioral log data associated with the members exhibiting recruiting intent, and classifies the behavioral log data as recruiting intent signature data. Finally, in operation 405, the prediction module 304 performs prediction modelling based on the recruiting intent signature data and a prediction model, to identify members of the online social network service that are associated with behavioral log data matching the recruiting intent signature data. Accordingly, the prediction module 304 may identify all members of an online social network service that exhibit recruiting intent at a given time. Each of the operations in the method 400 will now be described in greater detail.

Referring back to the method 400 in FIG. 4, in operation 401, the identification module 302 identifies a set of members of an online social network service (e.g., LinkedIn, Facebook, Twitter, etc.) that self-identify as recruiters. In various embodiments described herein, the members that self-identify as recruiters may also be referred to as “Recruiters”. For example, as illustrated in FIG. 1, the member base 100 of an online social network service such as LinkedIn may include various groups of members, including a set of members that self-identify as recruiters, or Recruiters 101.

In some embodiments, the identification module 302 may identify these members by accessing member profile data of each of the members of the online social network service, and by identifying members that are associated with member profile data indicating that the member is a recruiter and/or self identifies a recruiter. For example, the identification module 302 may determine that a member is a recruiter based on any information in the member's profile data or on the member's profile page that indicates or suggests that the member is a recruiter.

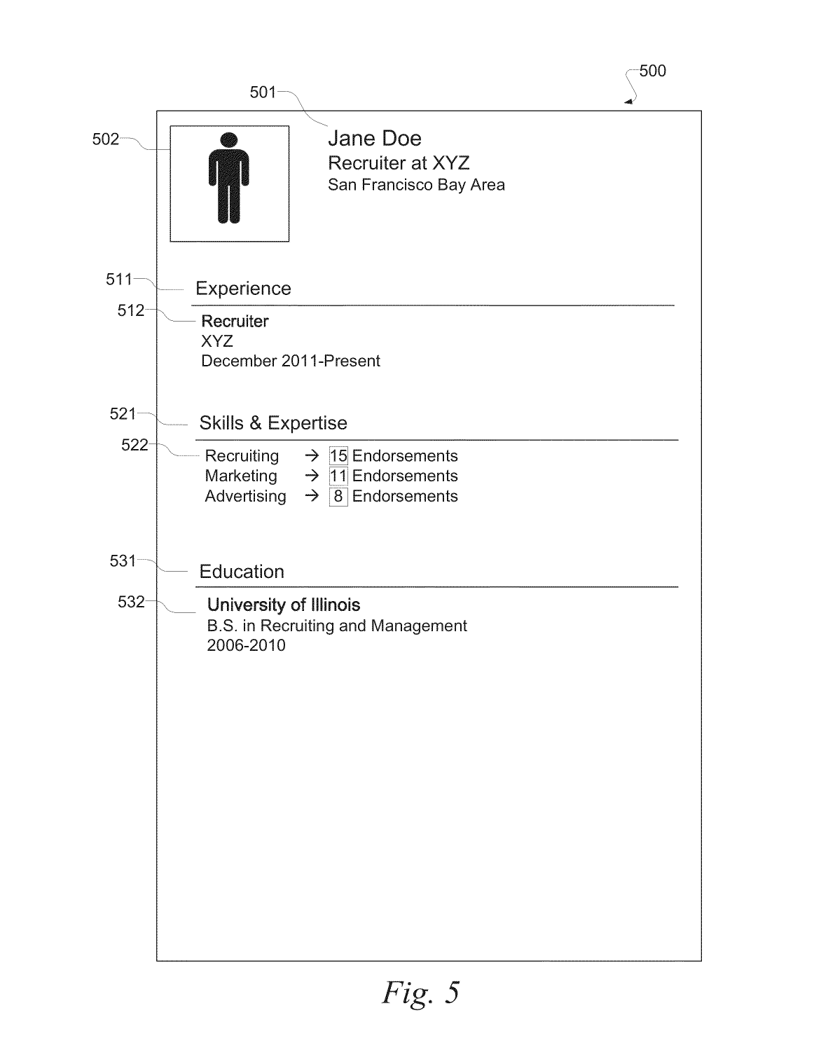

For example, each member of an online social network service (e.g., LinkedIn) may be associated with a member profile page that includes various information about that member. An example of a member profile page 500 of a member (e.g., a LinkedIn® page of a member “Jane Doe”) is illustrated in FIG. 5. As seen in FIG. 5, the member profile page 500 includes identification information 501, such as the member's name (“Jane Doe”), the member's current employment position (“Recruiter at XYZ”), and geographic address/location information (“San Francisco Bay Area”). The member's profile page 500 also includes a photo area 502 for displaying a photograph of the member. Further, the member profile page 500 includes various sections (also known as fields). For example, member profile page 500 includes an experience section 511 including listings of experience positions (e.g., employment experience position 512), a skills and expertise section 521 including listings of various skills 522 of the member and endorsements of each of these skills received by other members, and an education section 531 including listings of educational credentials of the member (e.g., university degree or diploma 532 earned or currently being earned by the member). Note that the member profile page 500 is merely exemplary, and while the member profile page 500 includes certain sections or fields (e.g., experience sections and educations sections), it is apparent that these sections or fields may be supplemented or replaced by other sections or fields (e.g., a general portfolio section/field, a multimedia section/field, an art portfolio section/field, a music portfolio section/field, a photography portfolio section/field, and so forth). Those skilled in the art will understand that a member profile page may include other information, such as various identification information (name, username, email address, geographic address, networks, location, phone number, etc.), education information, employment information, resume information, activities, group membership, images, photos, preferences, news, status, links or URLs on the profile page, and so forth.

In some embodiments, by analyzing the member profile data and/or member profile page of a member of a social network service, the identification module 302 may identify various member attributes that indicate that the member is a recruiter. Examples of such recruiter attributes include a recruiter-focused experience position (e.g., the user Jane Doe in FIG. 5 has indicated that she is currently a recruiter at XYZ), a recruiter-focused employer (e.g., perhaps the employer XYZ in FIG. 5 is a known recruiting company), a recruiter-focused education position (e.g., perhaps a degree in recruiting and management is a known credential for recruiters), a recruiter-focused academic institution (e.g., perhaps the University of Illinois is a known alma mater of recruiters), a recruiter-focused skill (e.g., see “Recruiting” skill in FIG. 5), a recruiter-focused endorsement (e.g., perhaps the member has received a significant number of endorsements for the skill of “Recruiting”, as seen in FIG. 5), and so on. Recruiter attributes are not limited to the examples described above, and may include any information included in a member profile page or member profile data that indicates that the member may be a recruiter. Examples of such information include a member having a member profile photo that includes references associated with recruiting (e.g., words, titles, company names, company logos, etc.), or a member being connected to a significant number of other recruiters, or a member following an influencer that it is a known recruiter or that self-identifies as a recruiter, or a member being a member of a group that is associated with recruiting, or a member following a company or educational institution that is associated with recruiting, and so on.

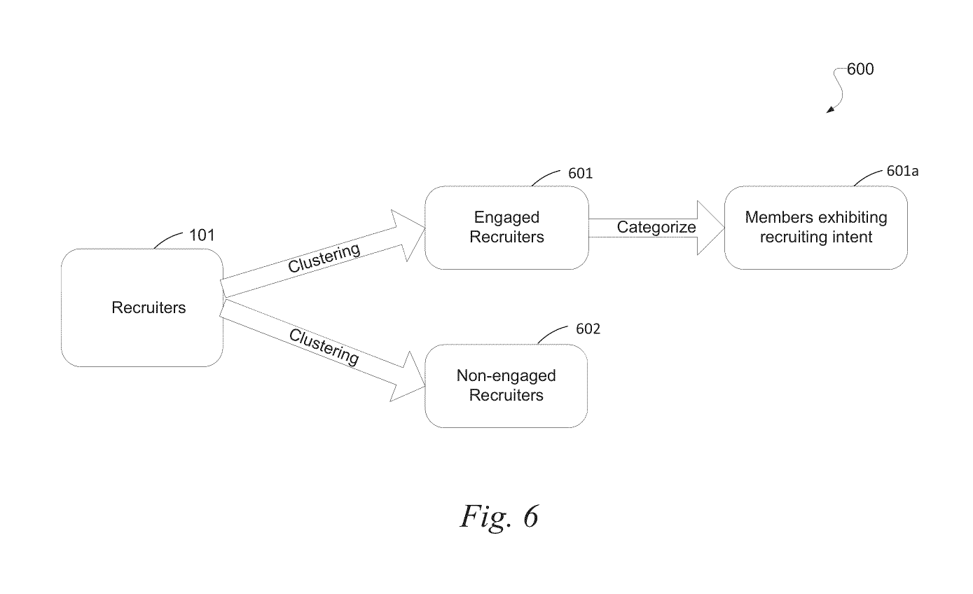

Referring back to the method 400 in FIG. 4, after the identification module 302 identifies recruiters (i.e., the members of the online social network service that self-identify as recruiters) in operation 401, then in operation 402, the identification module 302 clusters these recruiters into a group of engaged recruiters and a group of non-engaged recruiters. For example, as illustrated in FIG. 6, the identification module 302 may cluster the recruiters 101 into the group of engaged recruiters 601 and the group of non-engaged recruiters 602.

As described herein, “clustering” is a process that involves separating or segmenting a group of members into one or more sub-groups or subsets of members, based on various clustering criteria. In some example embodiments, the clustering criteria may include measures of how engaged each of the recruiters are with various products of the online social network service, where the products may correspond to, for example, webpages, content within webpages, features, components, services, subscriptions, email/notification services, etc., associated with the online social network service. For example, in some embodiments, the identification module 302 may analyze the interactions between each of the recruiters 101 and the various products of the online social network, and the identification module 302 may then separate the recruiters 101 into the group of engaged recruiters 601 and the second group of non-engaged recruiters 602, based on the analyzed interactions. In other words, the identification module 302 may classify the recruiters 101 that demonstrate a high level of engagement with one or more products of the online social network service as engaged recruiters 601, and the identification module 302 may classify the recruiters 101 that demonstrate a relatively low level of engagement with one or more products of the online social network service as the non-engaged recruiters 602.

According to various exemplary embodiments, the identification module 302 may analyze the interactions between each of the recruiters and the various products of the online social network service, by first accessing behavioral log data describing various user actions, interactions, activity, behaviour, etc., associated with each of the recruiters. Such behavioral log data may take the form of records with information indicating that, for example, “user X viewed webpage W at time T”, or “user X clicked on portion P, feature F, user-interface element E, etc., on webpage W at time T”, and so on, as understood by those skilled in the art. Such behavioral log data may be stored at, for example, the database 32 illustrated in FIG. 2. Instead, or in addition, such log data may be stored locally at, for example, the database 306 illustrated in FIG. 3, or may be stored remotely at a database, data repository, storage server, etc., that is accessible by the recruiting intent determination system 300 via a network (e.g., the Internet).

After accessing the log data associated with each of the recruiters 101, the identification module 302 may determine how engaged each of the members of the online social network service are. For example, in some embodiments, the identification module 302 may analyze the number of page views of various webpages of the social network service (e.g., homepages, jobs-related webpages, career-related webpages, recruiting-related webpages, advertising-related webpages, member profile webpages, group profile webpages, company profile webpages, education profile webpages, influencer profile webpages, news/updates webpages, mail/inbox webpages, etc.) by each of the recruiters in a given time period, in order to determine a level of engagement that each of the recruiters has with the online social network service. For example, recruiters that regularly (and/or have recently) viewed a significant number of one or more of the aforementioned webpages may be classified by the identification module 302 as engaged recruiters 601, whereas recruiters that have not regularly (and/or have not recently) viewed a significant number of one or more of the aforementioned webpages may be classified by the identification module 302 as engaged recruiters 602. In this way, the identification module 302 may separate the recruiters 101 into a group of engaged recruiters 601 and a group of non-engaged recruiters 602.

In some embodiments, the identification module 302 may take into account the total number of page views of multiple webpages or multiple different types of webpages, whereas in other embodiments, the identification module 302 may take into account the total number of page views of a particular webpage or a particular type of webpage. In some embodiments, views of a specific type or types of webpages (such as a recruiting-focused webpages or jobs webpage) may be ranked higher by the identification module 302 than the views of other types of webpages (such as a company webpage, influencer webpage, University webpage, etc.).

In some embodiments, the identification module 302 may calculate an engagement score associated with each of the recruiters 101 representing a level of engagement of each of the recruiters 101 with various products of the online social network service (using one or more techniques described above). For example, recruiters that regularly (and/or have recently) viewed a significant number of webpages associated with the social network service may be assigned a higher engagement score by the identification module 302, whereas recruiters that have not regularly (and/or have not recently) viewed a significant number of one or more of webpages associated with the online social network service may be assigned a lower engagement score by the identification module 302. Thereafter, the identification module 302 may separate the recruiters 101 into a group of engaged recruiters 601 and a group of non-engaged recruiters 602, based on the engagement scores associated with each of the recruiter's 101. For example, in some embodiments, the identification module 302 may categorize any recruiter 101 with an engagement scores greater than a predetermined threshold as an engaged recruiters 601, and categorize any recruiter 101 with an engagement score lower than a predetermined threshold as a non-engaged recruiter 602. In other embodiments, the identification module 302 may determine an average, median, or mean engagement score for all the recruiters 101, and any one of the recruiters 101 having a greater engagement score may be categorized as an engaged recruiter 601, whereas any recruiter 101 with a lower engagement score may be categorized as a non-engaged recruiter 602. The identification module 302 may use any other statistical analysis techniques understood by those skilled in the art in order to cluster the recruiters 101 (e.g., the identification module 302 may analyze the distribution of engagement scores of each of the recruiters 101, in order to identify statistically-significant clusters of higher engagement scores and lower engagement scores, etc.).

Various examples above refer to an analysis of page views of various webpages in order to determine level of engagement of each of the recruiters 101 with various products of the online social network service. However, it is understood that the identification module 302 may analyze any aspect of user actions, interactions, activity, behaviour, etc., associated with each of the recruiters 101, in order to determine a level of engagement of each of the recruiters 101 with the various products of the online social network service. For example, the identification module 302 may analyze a number of times a recruiter has transmitted or received a notification message (e.g., a LinkedIn career-mail message), a number of times a recruiter has accessed a jobs page, a number of times a recruiter has posted a job on a jobs page, a number of times recruiter has viewed a job posted on a jobs page, number of times a recruiter has submitted various types of social activity signals (e.g., likes, shares, follows, comments, views, hover responses, close/hide responses, conversions, etc.) in association with various types of content posted on an online social network service, and so on.

According to various exemplary embodiments, the identification module 302 may validate the clustering of the recruiters 101 into the group of engaged recruiters 601 and the group of non-engaged recruiters 602, by determining that an engagement metric associated with the group of engaged recruiters 601 indicates a greater degree of engagement with the online social network service in comparison to the same engagement metric for the group of non-engaged recruiters 602. For example, the aforementioned engagement metric may include a measure of a number of days of active use of the online social network service during a specific time period. In some embodiments, if the identification module 302 determines that the a particular one of the engaged recruiters 601 is associated with a lower engagement metric (e.g., a low number of days of active use of the online social network service during a specific time period), then the identification module 302 may reassign this particular member to the group of non-engaged recruiters 602. It is understood that the engagement metric of ‘days of active use’ is simply one non-limiting example of an engagement metric that may be utilized during this validation process, and other engagement metrics understood by those skilled in the art may be used during this validation process. This validation process may occur after, for example, the operation 402 in the method 400.

Referring back to the method 400 in FIG. 4, after the identification module 302 clusters the recruiters 101 into a group of engaged recruiters 601 and non-engaged recruiters 603 (in operation 402), then, in operation 403, the identification module 302 categorizes the group of engaged recruiters 601 as members exhibiting recruiting intent. For example, as illustrated in FIG. 6, the engaged recruiters 601 have been categorized as member exhibiting recruiting intent 601a. As described herein, members exhibiting recruiting intent are members that exhibit behavior indicating they are using (or intend to use) the online social network service for recruiting. Thus, the categorization of the engaged recruiters 601 as members exhibiting recruiting intent represents an assumption on the part of the recruiting intent determination system 300 that members that 1) self-identify as recruiters and 2) are engaged members of the online social network service, are, in fact, members exhibiting recruiting intent.

According to various exemplary embodiments, the identification module 302 may validate the categorization of the engaged recruiters 601 as members exhibiting recruiting intent 601a. In other words, the identification module 302 may check that each of the engaged recruiters 601 are actually members exhibiting recruiting intent, because it is possible that some of the engaged recruiters 601 may not be actively recruiting. For example, perhaps one of the engaged recruiters 601 self-identified themselves as a recruiter on their profile by mistake, or perhaps one of the engaged recruiters 601 previously self-identified themselves as a recruiter on their profile, but they are no longer actively recruiting and they have not updated their profile.

According to various exemplary embodiments, the identification module 302 may validate the categorization of the engaged recruiters 601 as members exhibiting recruiting intent 601a, by determining that likely indicators of recruiting intent are overrepresented in the group of engaged recruiters 601. This validation process may occur after, for example, the operation 403 in the method 400. According to various exemplary embodiments, likely indicators of recruiting intent may include a number of jobs posted by a member, a number of career mail messages transmitted by a member, and a member subscription to a talent-finder service, and so on. Note that, as described herein, a career mail message is an email message (or some other type of electronic message/notification) where the sender explicitly specifies the category of the email message as “Career opportunity” or something related to recruiting (e.g., by selecting the category of “Career opportunity” from a list of email category options). Such career mail messages may be transmitted via a messaging service associated with an online social network service such as LinkedIn. Accordingly, in some example embodiments, the identification module 302 identifies a career mail message simply by analyzing the relevant category information associated with the email (e.g., category information included in the header of the email), and thus the identification module 302 does not parse the actual subject or message contents of the email composed by the sender when determining if the email is a career mail message.

Accordingly, in various exemplary embodiments, the identification module 302 may access behavioral log data associated with each of the engaged recruiters 601, and may check that the likely indicators of recruiting intent are overrepresented in this behavioral log data. In some embodiments, data describing the aforementioned likely indicators of recruiting intent may be stored locally at, for example, the database 306 illustrated in FIG. 3, or may be stored remotely at a database, data repository, storage server, etc., that is accessible by the recruiting intent determination system 300 via a network (e.g., the Internet). It is understood that the aforementioned likely indicators of recruiting intent are merely non-limiting examples and, as other likely indicators of recruiting intent are identified by the system 300 (e.g., various elements of the recruiting intent signature data described below), the identification module 302 may utilize these indicators during this validation process.

In some exemplary embodiments, if the identification module 302 determines that the behavioral log data associated with a particular member of the engaged recruiters 601 does not include the aforementioned indicators of recruiting intent, the identification module 302 may reclassify this member as belonging to the group of non-engaged recruiters 602. However, it is understood that this technique is optional. For example, in other embodiments, after the clustering is performed, the system will not reassign members who are not positive for one or more of the likely indicators of recruiting intent. This is because such members have nevertheless exhibited other signals that make up the overall signature that caused them to be clustered with the highly engaged group 601.

According to various exemplary embodiments, the clustering criteria used for the clustering process (in operation 402 in the method 400) may be different from the likely indicators of recruiting intent that are used to verify the clustering process. For example, if the identification module 302 clusters the recruiters 101 based in part on a number of jobs posted by a member, then this specific behavioral signal will not be utilized by the recruiting intent determination system 300 for the purposes of validating the clustering of the recruiters 101. Similarly, if the indicators of recruiting intent that will be utilized for the purposes of validating the clustering include a number of jobs posted by a member, a number of career mail messages transmitted by a member, and a member subscription to a talent-finder service, then these signals are not utilized by the recruiting intent determination system 300 during the clustering process itself. This technique may be advantageous because the validation of the clustering is more effective if it is performed based on different behavioral signals then those used in the clustering process itself.

Referring back to the method 400 in FIG. 4, after the identification module 302 categorizes the group of engaged recruiters 601 as members exhibiting recruiting intent (in operation 403), then, in operation 404, the prediction module 304 accesses behavioral log data describing the behavior of the members exhibiting recruiting intent. Such behavioral log data may be stored at, for example, the database 32 illustrated in FIG. 2. Instead, or in addition, such behavioral log data may be stored locally at, for example, the database 306 illustrated in FIG. 3, or may be stored remotely at a database, data repository, storage server, etc., that is accessible by the recruiting intent determination system 300 via a network (e.g., the Internet). Further, in operation 404, the prediction module 304 classifies the behavioral log data as “recruiting intent signature data” that describes behavior that is in some way indicative or representative of the behavior of members of an online social network service that have recruiting intent. As described in more detail below, the prediction module 304 may utilize this recruiting intent signature data to identify all the members of the online social network service that have recruiting intent, by finding members that have behavioral log data matching the recruiting intent signature data.

In operation 405 in FIG. 4, the prediction module 304 performs a prediction modelling process based on the recruiting intent signature data (i.e., the behavioral log data associated with the members exhibiting recruiting intent 601a) in order to identify all members of the online social network service that have recruiting intent. According to various exemplary embodiments described in more detail below, the aforementioned prediction modeling process may include training a prediction model (e.g., a logistics regression model) based on the recruiting intent signature data that represents the behavior of members having recruiting intent 601a. Thereafter, the trained prediction model may analyze the behaviour of a particular member of the online social network service to predict a likelihood or probability that the particular member has recruiting intent. For example, the trained prediction model may be utilized to determine whether the behaviour of the particular member matches or conforms to the recruiting intent signature data. This may then be repeated for all the members of the online social network service, in order to identify all members of the online social network service that have recruiting intent.

The prediction module 304 may use any one of various known prediction modeling techniques to perform the prediction modeling. For example, according to various exemplary embodiments, the prediction module 304 may apply a statistics-based machine learning model such as a logistic regression model to the recruiting intent signature data. As understood by those skilled in the art, logistic regression is an example of a statistics-based machine learning technique that uses a logistic function. The logistic function is based on a variable, referred to as a logit. The logit is defined in terms of a set of regression coefficients of corresponding independent predictor variables. Logistic regression can be used to predict the probability of occurrence of an event given a set of independent/predictor variables. A highly simplified example machine learning model using logistic regression may be ln[p/(1−p)]=a+BX+e, or [p/(1−p)]=exp(a+BX+e), where ln is the natural logarithm, logₑₓₚ, where exp=2.71828 . . . , p is the probability that the event Y occurs, p(Y=1), p/(1−p) is the “odds ratio”, ln[p/(1−p)] is the log odds ratio, or “logit”, a is the coefficient on the constant term, B is the regression coefficient(s) on the independent/predictor variable(s), X is the independent/predictor variable(s), and e is the error term. In some embodiments, the independent/predictor variables of the logistic regression model may be behavioral log data associated with members of an online social network service (where the behavioral log data may be encoded into feature vectors). The regression coefficients may be estimated using maximum likelihood or learned through a supervised learning technique from the recruiting intent signature data, as described in more detail below. Accordingly, once the appropriate regression coefficients (e.g., B) are determined, the features included in a feature vector (e.g., behavioral log data associated with a member of a social network service) may be plugged in to the logistic regression model in order to predict the probability that the event Y occurs (where the event Y may be, for example, a particular member of an online social network service having recruiting intent). In other words, provided a feature vector including various behavioral features associated with a particular member, the feature vector may be applied to a logistic regression model to determine the probability that the particular member has recruiting intent. Logistic regression is well understood by those skilled in the art, and will not be described in further detail herein, in order to avoid occluding various aspects of this disclosure. The prediction module 304 may use various other prediction modeling techniques understood by those skilled in the art to predict whether a particular has recruiting intent. For example, other prediction modeling techniques may include other machine learning models such as a Naïve Bayes model, a support vector machines (SVM) model, a decision trees model, and a neural network model, all of which are understood by those skilled in the art.

According to various embodiments described above, the recruiting intent signature data may be used for the purposes of both off-line training (for generating, training, and refining a prediction model and or the coefficients of a prediction model) and online inferences (for predicting whether a particular member exhibits recruiting intent). For example, if the prediction module 304 is utilizing a logistic regression model (as described above), then the regression coefficients of the logistic regression model may be learned through a supervised learning technique from the recruiting intent signature data. Accordingly, in one embodiment, the recruiting intent determination system 300 may operate in an off-line training mode by assembling the recruiting intent signature data into feature vectors. (For the purposes of training the system, the system generally needs both positive examples of behaviour of members having recruiting intent, as well as negative examples of behaviour of members that do not have recruiting intent, as will be described in more detail below). The feature vectors may then be passed to the prediction module 304, in order to refine regression coefficients for the logistic regression model. For example, statistical learning based on the Alternating Direction Method of Multipliers technique may be utilized for this task. Thereafter, once the regression coefficients are determined, the recruiting intent determination system 300 may operate to perform online (or offline) inferences based on the trained model (including the trained model coefficients) on a feature vector representing the behaviour of a particular member of the online social network service. For example, according to various exemplary embodiments described herein, the recruiting intent determination system 300 is configured to predict the likelihood that a particular member has recruiting intent, based on whether the behaviour of the particular member matches or conforms to the recruiting intent signature data that was utilized to train the model. In some embodiments, if the probability that the particular member has recruiting intent is greater than a specific threshold (e.g., 0.5, 0.8, etc.), then the prediction module 304 may classify that particular member as having recruiting intent. In other embodiments, the prediction module 304 may calculate a recruiting intent score for the particular member, based on the probability that the particular member has recruiting intent. Accordingly, the prediction module 304 may repeat this process for all the members of an online social network service.

According to various exemplary embodiments, the off-line process of training the prediction model based on the recruiting intent signature data may be performed periodically at regular time intervals (e.g., once a day), or may be performed at irregular time intervals, random time intervals, continuously, etc. Thus, since recruiting intent signature data may change over time based on changes in the behavior of the members exhibiting recruiting intent 601a, it is understood that the prediction model itself may change over time (based on the current recruiting intent signature data being used to train the model). The behaviour of people having recruiting intent 601a may change over time because, for example, industry practice within the field of recruiting may change, or features, products and technology of the online social network service may change, and so on. Thus, the operation 405 in the method 400 may comprise identifying all the members of an online social network service that are exhibiting recruiting intent at a specific time.

Non-limiting examples of behaviour representative of members having recruiting intent (e.g., the positive examples described above) may include transmitting or receiving a particular number of mail messages (e.g., career mail messages), posting a particular number of jobs, viewing a particular number of jobs, viewing a particular amount of member profiles, performing a particular number of searches for members, and so on. Non-limiting examples of behavior representative of members not having recruiting intent (e.g., the negative examples described above) includes a particular number of views of jobs-related pages (e.g., jobs detail pages), a particular number of views of jobs seeking home pages, a particular number of views of a member's own profile, and a particular number of company searches, and so on. Of course, such behavioral signals are merely exemplary, and the behavioral signals identified by the prediction module 304 may change continuously as the ecosystem of the online social network service evolves over time.

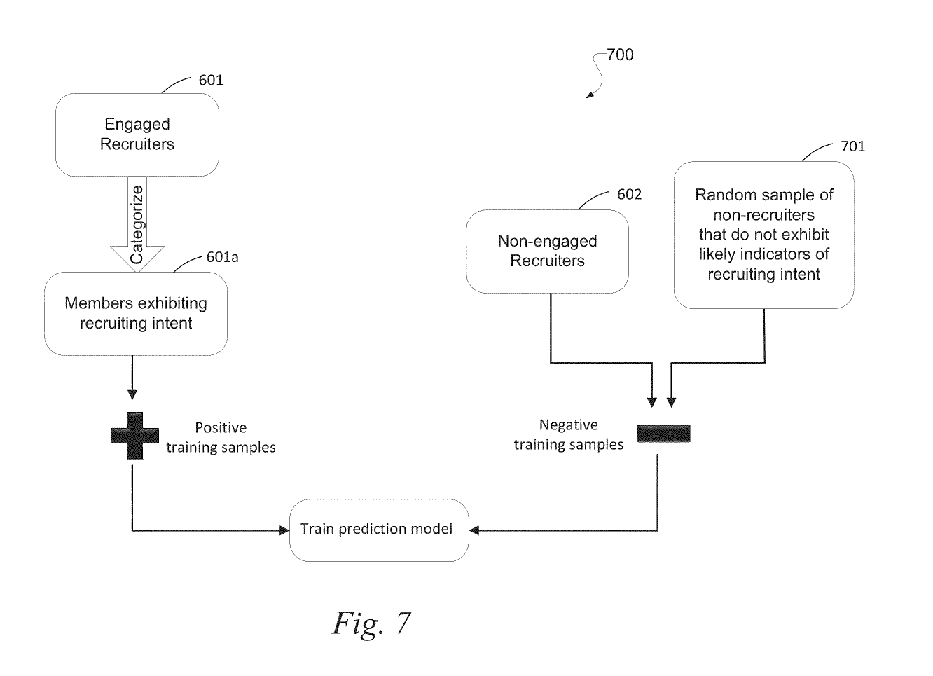

As described above, for the purposes of training the logistic regression prediction model, the prediction model generally requires both positive examples of behaviour of members having recruiting intent, as well as negative examples of behaviour of members that do not have recruiting intent. According to various exemplary embodiments, the aforementioned recruiting intent signature data (i.e., behavioral log data associated with the engaged recruiters 601) may be classified as positive examples for training the prediction model. In other words, the recruiting intent signature data may be treated by the prediction module 304 as representative samples of behavior associated with members having recruiting intent, and the prediction module 304 may train the prediction model based on the recruiting intent signature data (e.g., by refining the coefficients of the prediction model). In this way, the prediction model may be later utilized to analyze behavioral log data associated with a given member, in order to determine whether such behavioral log data conforms to or matches the positive samples (i.e. the recruiting intent signature data), and to thus determine whether the given member has recruiting intent. For example, as illustrated in FIG. 7, the recruiting intent signature data associated with the engaged recruiters 601 (who were categorized by the recruiting intent determination system 300 as members exhibiting recruiting intent 601a) may be utilized as positive training samples for training a prediction model.

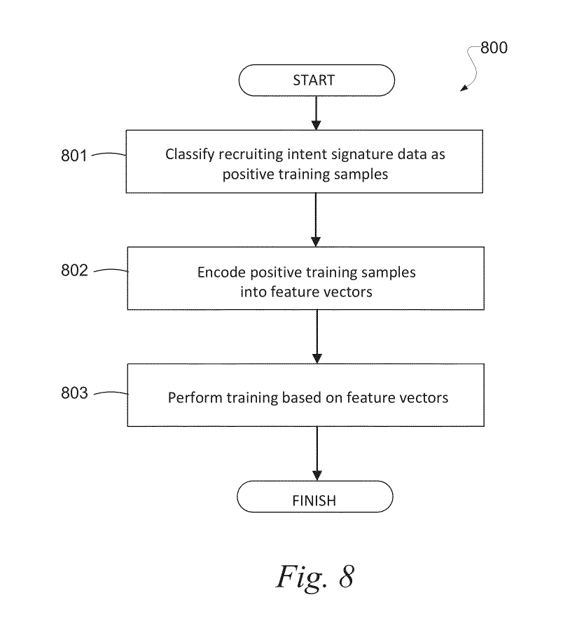

FIG. 8 is a flowchart illustrating an example method 800, consistent with various embodiments described above. The method 800 may be performed at least in part by, for example, the recruiting intent determination system 300 illustrated in FIG. 3 (or an apparatus having similar modules, such as a client machine and/or application server). In operation 801, the prediction module 304 classifies the recruiting intent signature data associated with the members exhibiting recruiting intent as positive training samples for training the prediction model. In operation 802, the prediction module 304 encodes the positive training samples into feature vectors. In operation 803, the prediction module 304 performs a training operation to refine coefficients of a logistic regression model, based on the feature vectors.

According to various exemplary embodiments, behavior log data associated with the group of non-engaged recruiters 602 may be classified as negative training samples for training the prediction model. Moreover, behavior signal data associated with a random selection of members of the online social network service that (1) do not self-identify as recruiters and that (2) do not exhibit the likely indicators of recruiting intent described above, may also be classified as negative training samples for training the prediction model. In other words, the aforementioned data may be treated by the prediction module 304 as representative samples of behavior associated with members that do not have recruiting intent, and the prediction module 304 may train the prediction model based on the such data (e.g., by refining the coefficients of the prediction model). In this way, the prediction model may be later utilized to analyze behavioral log data associated with a given member, in order to determine whether such behavioral log data conforms to or matches the negative samples, and to thus determine whether the given member does not have recruiting intent. For example, as illustrated in FIG. 7, the recruiting intent signature data associated with the non-engaged recruiters 602, as well as behavioral log data associated with a random sample of non-recruiters that do not exhibit likely indicators of recruiting intent 701, may be utilized as negative training samples for training a prediction model. The input of the behavioural data 701 associated with non-recruiters as negative examples for training the model may be advantageous because, in some example embodiments, the input of only the behavioural data of the non-engaged recruiters 602 as negative examples may unfairly bias the model towards members that self-identify as recruiters 101.

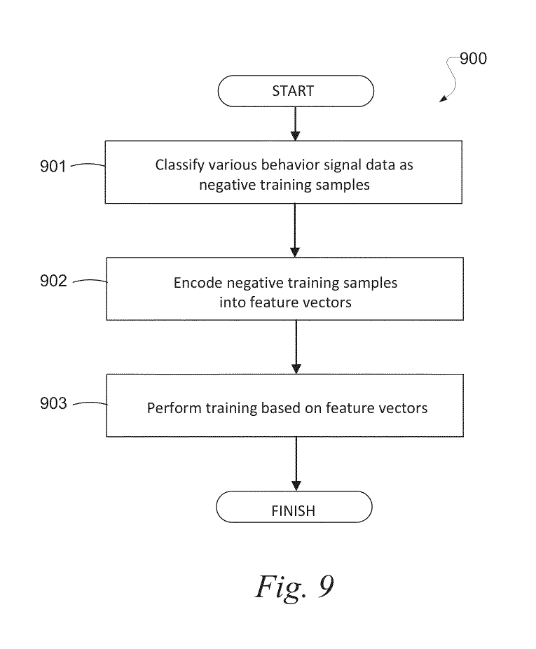

FIG. 9 is a flowchart illustrating an example method 900, consistent with various embodiments described above. The method 900 may be performed at least in part by, for example, the recruiting intent determination system 300 illustrated in FIG. 3 (or an apparatus having similar modules, such as a client machine and/or application server). In operation 901, the prediction module 304 classifies various behavior log data as negative training samples for training a prediction model. For example, the prediction module 304 may classify behavior log data associated with the group of non-engaged recruiters as negative training samples for training the prediction model. As another example, the prediction module 304 may classify behavior signal data associated with a random selection of members of the online social network service that do not self-identify as recruiters and that do not exhibit indicators of recruiting intent as additional negative training samples for training the prediction model. In operation 902, the prediction module 304 encodes the negative training samples into feature vectors. In operation 903, the prediction module 304 performs a training operation to refine coefficients of a logistic regression model, based on the feature vectors.

According to various exemplary embodiments, the prediction module 304 is configured to assign a recruiting intent score to each of the members of the online social network service. Based on the recruiting intent score, the prediction module 304 may determine whether each member of the online social network service is a member exhibiting recruiting intent or not. The recruiting intent determination system 300 may then adjust a content experience of each member of the online social network service, depending on whether that member exhibits recruiting intent or not.

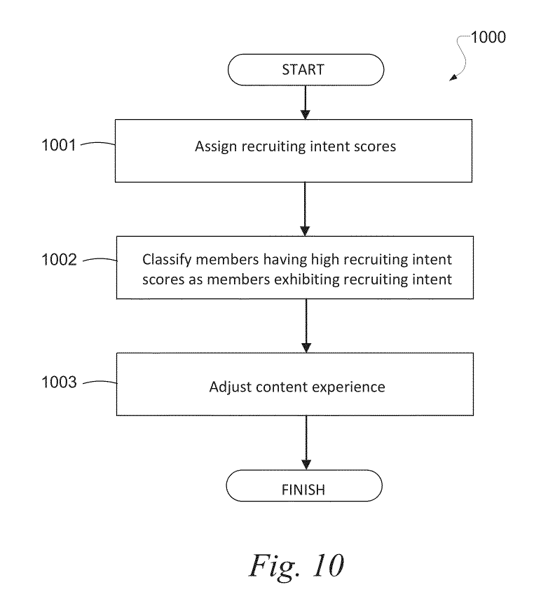

For example, FIG. 10 is a flowchart illustrating an example method 1000, consistent with various embodiments described above. The method 1000 may be performed at least in part by, for example, the recruiting intent determination system 300 illustrated in FIG. 3 (or an apparatus having similar modules, such as a client machine and/or application server). The method 1000 may be performed after, for example, the method 400 in FIG. 4. In operation 1001, the prediction module 304 assigns a recruiting intent score to each of the members of the online social network service, based on a degree of the match between the behavioral log data of the corresponding member and the recruiting intent signature data. For example, if a logistic regression prediction model is utilized to determine the probability that a particular member exhibits recruiting intent, then the recruiting intent score for that member may correspond to the probability output by the logistic regression prediction model. In operation 1002, the prediction module 304 classifies members of the online social network service having recruiting intent scores greater than a specific threshold as members exhibiting recruiting intent.

In operation 1003 in FIG. 10, the prediction module 304 adjusts a content experience for one or more members of an online social network service. For example, the prediction module 304 may adjust a content experience for the members exhibiting recruiting intent, such as by displaying various recommendations for recruiter-focused content. For example, in some embodiments, the identification module 302 may display recommendations for recruiter-focused subscription offers (e.g., a Talent Finder subscription on LinkedIn), recommendations for specific member connections (e.g., other recruiters, human resources (HR) personnel of companies, high level executives of companies, candidates for jobs, etc.), recommendations for recruiter-focused group memberships, recommendations for following a recruiting company, recruiting organization, University, or other entity that is known to be associated with recruiting, and so on. In some embodiments, the prediction module 304 may display recommendations for recruiter-focused articles, publications, news items, advertisements, and other content that may be targeted at recruiters or are otherwise of interest to recruiters. Accordingly, the identification module 302 is configured to adjust any aspect of the online social network experience in order to help recruiters to recruit faster, more efficiently, and more easily.

According to various exemplary embodiments, after determining that a particular member exhibits recruiting intent, the prediction module 304 may also adjust a content experience on the online social network service for other members that may interact with this particular member exhibiting recruiting intent. For example, in some embodiments, when another member of the online social network service views the profile page of this particular member, the prediction module 304 may display recruiter badge information on the member profile page of this particular member indicating that this particular member is a recruiter, is currently recruiting, is currently looking for talent, etc. In some embodiments, the prediction module 304 may display this recruiter badge information to any members of the online social network service that view the member profile page of this particular member. In other embodiments, the prediction module 304 may selectively display this recruiter badge information only to members of the online social network service designated by the system 300 as job seekers. For example, in some embodiments, the system 300 may include a job seeker prediction module 308 (illustrated in FIG. 3) configured to determine whether a particular member of the online social network service is a job seeker. Thus, when such a member classified as a job seeker views the member profile page of a member exhibiting recruiting intent, the prediction module 304 may display the aforementioned recruiter badge information.

According to various exemplary embodiments, the job seeker prediction module 308 may determine that a member is a job seeker based on, for example, whether the member looks at a particular number of job postings during a given time interval, or whether the member signs up for a job seeker subscription on LinkedIn, or whether the member views articles related to finding jobs, and so on. Various techniques for identifying job seekers (e.g., by the job seeker prediction module 308 of the system 300) are described in greater detail in pending U.S. patent application Ser. No. 13/684,013, filed on Nov. 21, 2012, entitled “Customizing a user experience based on a job seeker score”, which is incorporated by reference herein.

In some embodiments, the prediction module 304 may display a list of recruiters to the job seekers identified by the job seeker prediction module 308, where the list of recruiters may be ranked based on the recruiting intent score associated with each of the recruiters (e.g., the recruiter with the highest recruiting intent score is displayed highest in the list).

In some embodiments, if the aforementioned job seeker prediction module 308 determines that a particular user is a job seeker, then the job seeker prediction module 308 may determine whether this job seeker is a good candidate for a job posted by a members exhibiting recruiting intent (or posted by a company or university associated with a member exhibiting recruiting intent) by, for example, comparing attributes of the job seeker with job requirements criteria associated with the posted job. The prediction module 304 may then recommend such a job seeker as a job candidate to the member exhibiting recruiting intent. Thus, if the system 300 determines that a member is a job seeker and is an excellent match for a job posted by a company, then the system 200 may transmit a message to a member of the company that exhibits recruiting intent (e.g., a manager, CXO, etc.), where the message recommends the job seeker as a job candidate for the posted job.

According to various exemplary embodiments, the aforementioned job seeker prediction module 308 may determine that a job seeker is searching for jobs associated with a particular industry (e.g., software programming), a particular location (e.g., the San Francisco Bay Area), a particular company (e.g., Google), particular skills (e.g., software engineering), particular experience or education credentials (e.g., B.S.E. in software engineering), and so on, by analyzing the jobs being viewed by the job seeker. Thereafter, the prediction module 304 may display a list of members with matching attributes (e.g., matching industry, matching location, matching company, matching skills, matching experience, matching education credentials, etc.), where the list of members is ranked based on their recruiting intent score. Accordingly, if the recruiting intent determination system 300 determines that a user is attempting to find a job at Google, for example, then the prediction module 304 may display the list of employees that work at Google that have the highest recruiting intent scores. The prediction module 304 may then invite the job seeker to connect with this individual, to transmit a message to this individual, and so on.

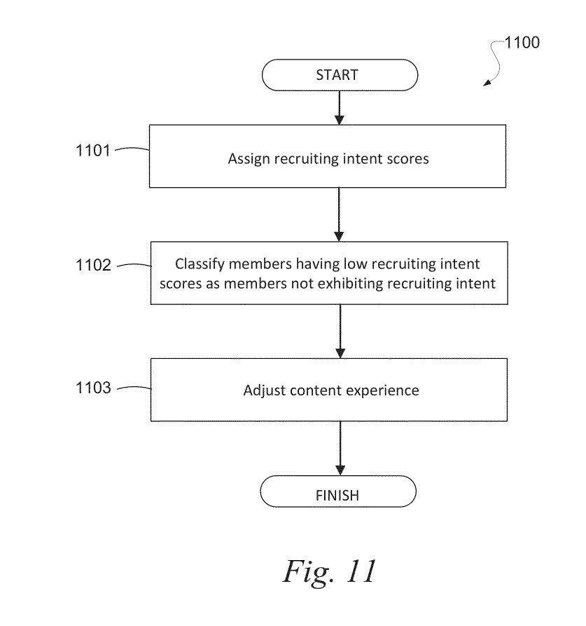

According to various exemplary embodiments, if the prediction module 304 determines that a particular member does not exhibit recruiting intent, the prediction module 304 may adjust content experience of this member accordingly, such as by directing them away from recruiter-focused content such as recruiter subscription packages. For example, FIG. 11 is a flowchart illustrating an example method 1100, consistent with various embodiments described above. The method 1100 may be performed at least in part by, for example, the recruiting intent determination system 300 illustrated in FIG. 3 (or an apparatus having similar modules, such as a client machine and/or application server). The method 1100 may be performed after, for example, the method 400 in FIG. 4. In operation 1101, the identification module 302 assigns a recruiting intent score to each of the members of the online social network service, based on a degree of the match between the behavioral log data of the corresponding member and the recruiting intent signature data. For example, if a logistic regression prediction model is utilized to determine the probability that a particular member exhibits recruiting intent, then the recruiting intent score for that member may correspond to this probability output by the logistic regression prediction model. In operation 1102, the identification module 302 classifies members of the online social network service having recruiting intent scores less than a specific threshold as members not exhibiting recruiting intent. In operation 1103, the identification module 302 adjusts a content experience for the members not exhibiting recruiting intent. For example, in some embodiments, the identification module 302 may prevent various recruiter-focused recommendations (described above) from being displayed to the members not exhibiting recruiting intent.

Various embodiments throughout describe a system configured to identify members of an online social network service that are currently using the service for the purposes of recruiting. According to various exemplary embodiments, the various techniques and embodiments described herein may instead or in addition be applied for identifying members actively using an online social network service for other efforts (e.g., sales, marketing, advertising, job searching, etc.). For example, in some embodiments, the system may identify members that self-identify as salespeople, marketers, advertisers, and so on, and thereafter the system may cluster these members into engaged and non-engaged members (e.g., engaged and non-engaged salespeople, marketers, advertisers, etc.), consistent with various embodiments described above. Thereafter, the system may access signature behavioral log data associated with the engaged members, and perform a prediction modeling process based on this behavioral log data in order to ultimately identify all members that exhibit behavior matching the aforementioned signature behavioral log data, consistent with various embodiments described herein. Accordingly, the system may identify all members of the online social network service that have sales intent, marketing intent, advertising intent, etc. (e.g., all the members that are currently actively using the online social network service for sales, marketing, advertising, and so on). Thereafter, the system may just a content experience for each of these members. For example, the members that have sales intent may be provided with recommendations for sales-related content, subscription offers, articles, publications, advertisements, news items, member connection recommendations, group connection recommendations, and so on.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

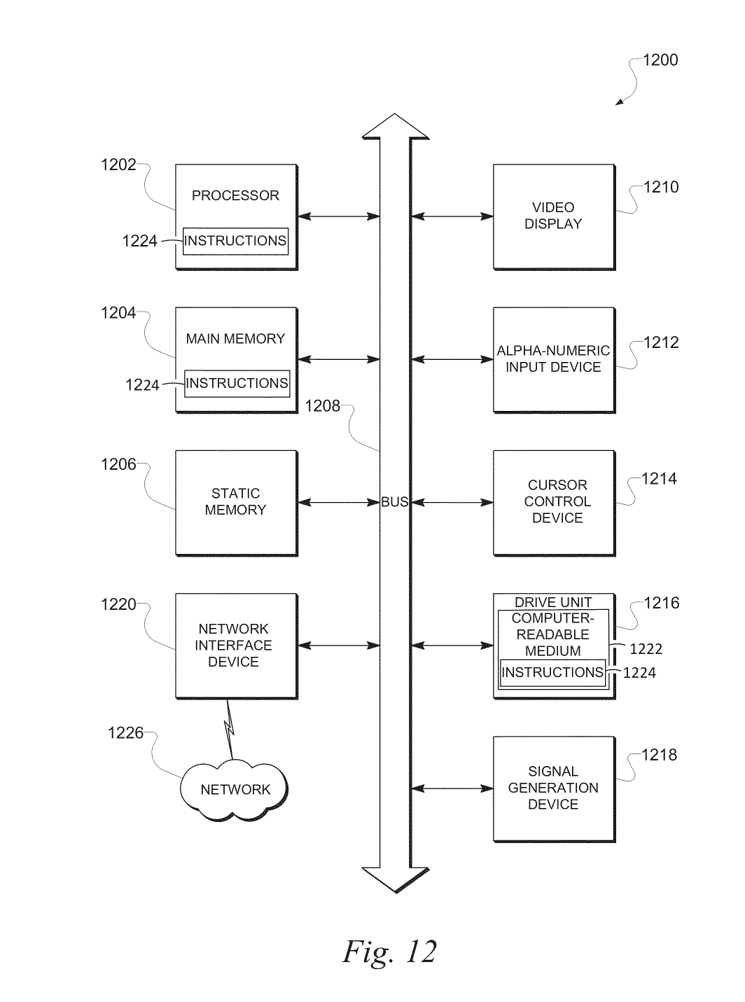

FIG. 12 is a block diagram of machine in the example form of a computer system 1200 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation device 1214 (e.g., a mouse), a disk drive unit 1216, a signal generation device 1218 (e.g., a speaker) and a network interface device 1220.

### Machine-Readable Medium

The disk drive unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
identifying a set of members of an online social network service that self-identify as recruiters;
clustering the set of members that self-identify as recruiters into a group of engaged recruiters and a second group of non-engaged recruiters;
categorizing the group of engaged recruiters as members exhibiting recruiting intent;
accessing behavioral log data associated with the members exhibiting recruiting intent, and classifying the behavioral log data as recruiting intent signature data; and
performing prediction modeling, by a machine including a memory and at least one processor, based on the recruiting intent signature data and a prediction model, to identify members of the online social network service that are associated with behavioral log data matching the recruiting intent signature data.

2. The method of claim 1, wherein the identifying comprises:
accessing member profile data of members of the online social network service; and
identifying the set of members as being associated with member profile data that includes recruiter attributes.

3. The method of claim 2, wherein the recruiter attributes include at least one of a recruiter-focused experience position, a recruiter-focused employer, a recruiter-focused education position, a recruiter-focused academic institution, a recruiter-focused skill, and a recruiter-focused endorsement.

4. The method of claim 2, wherein the clustering further comprises:
analyzing interactions by each member in the set with a plurality of products of the online social network service; and
separating the set of members into the group of engaged recruiters and the second group of non-engaged recruiters, based on the analyzed interactions.

5. The method of claim 1, wherein the clustering further comprises validating the clustering, based on determining that one or more engagement metrics associated with the group of engaged recruiters indicates a greater degree of engagement with the online social network service in comparison to one or more engagement metrics associated with the group of non-engaged recruiters.

6. The method of claim 5, wherein the engagement metric includes a measure of a number of days of active use of the online social network service during a specific time period.

7. The method of claim 1, wherein the categorizing further comprises:
validating the categorization of the group of engaged recruiters as members exhibiting recruiting intent, based on determining that indicators of recruiting intent are overrepresented in the group of engaged recruiters.

8. The method of claim 7, wherein the indicators include at least one of a number of jobs posted, a number of career mail messages transmitted, and a subscription to a talent-finder service.

9. The method of claim 1, wherein the performing of the prediction modeling further comprises:
classifying the recruiting intent signature data associated with the members exhibiting recruiting intent as positive training samples for training the prediction model.

10. The method of claim 9, wherein the performing of the prediction modeling further comprises:
encoding the positive training samples into feature vectors; and.
performing a training operation to refine coefficients of a logistic regression model, based on the feature vectors.

11. The method of claim 1, wherein the performing of the prediction modeling further comprises:
classifying behavior signal data associated with the group of non-engaged recruiters as negative training samples for training the prediction model.

12. The method of claim 11, wherein the performing of the prediction modeling further comprises:
classifying behavior signal data associated with a random selection of members of the online social network service that do not self-identify as recruiters and that do not exhibit indicators of recruiting intent as additional negative training samples for training the prediction model.

13. The method of claim 12, wherein the performing of the prediction modeling further comprises:
encoding the negative training samples into feature vectors; and.
performing a training operation to refine coefficients of a logistic regression model, based on the feature vectors.

14. The method of claim 1, wherein the prediction model is any one of a logistic regression model, a Naïve Bayes model, a support vector machines (SVM) model, a decision trees model, and a neural network model.

15. The method of claim 1, further comprising:
assigning a recruiting intent score to each of the members of the online social network service, based on a degree of the match between the behavioral log data of the corresponding member and the recruiting intent signature data.

16. The method of claim 15, further comprising:
classifying members of the online social network service having recruiting intent scores greater than a specific threshold as members exhibiting recruiting intent; and
providing recruiter-focused recommendations to the members exhibiting recruiting intent.

17. The method of claim 16, wherein the recruiter-focused recommendations include recommendations for job candidates, recruiter-focused subscription offers, recruiter-focused articles, recruiter-focused advertisements, recruiter-focused member connections, and recruiter-focused group memberships.

18. The method of claim 15, further comprising:
classifying members of the online social network service having recruiting intent scores less than a specific threshold as members not exhibiting recruiting intent; and
preventing recruiter-focused recommendations from being provided to the members not exhibiting recruiting intent.

19. A system comprising:
a machine including a memory and at least one processor;
an identification module, executable by the machine, configured to:
identify a set of members of an online social network service that self-identify as recruiters;
cluster the set of members that self-identify as recruiters into a group of engaged recruiters and a second group of non-engaged recruiters; and
categorize the group of engaged recruiters as members exhibiting recruiting intent; and
a prediction module configured to:
access behavioral log data associated with the members exhibiting recruiting intent, and classifying the behavioral log data as recruiting intent signature data; and
perform prediction modeling based on the recruiting intent signature data and a prediction model, to identify members of the online social network service that are associated with behavioral log data matching the recruiting intent signature data.

20. A non-transitory machine-readable storage medium comprising instructions that, when executed by one or more processors of a machine, cause the machine to perform operations comprising:
identifying a set of members of an online social network service that self-identify as recruiters;
clustering the set of members that self-identify as recruiters into a group of engaged recruiters and a second group of non-engaged recruiters;
categorizing the group of engaged recruiters as members exhibiting recruiting intent;
accessing behavioral log data associated with the members exhibiting recruiting intent, and classifying the behavioral log data as recruiting intent signature data; and
performing prediction modeling based on the recruiting intent signature data and a prediction model, to identify members of the online social network service that are associated with behavioral log data matching the recruiting intent signature data.
